(19) United States
(12) Patent Application Publication
(10) Pub. No.: US 2011/0133125 A1
(43) Pub. Date: Jun. 9, 2011

(54) INORGANIC PHOSPHOR PARTICLE

(76) Inventor: Masashi Shirata, Kanagawa (JP)

(21) Appl. No.: 13/056,884

(22) PCT Filed: Jul. 29, 2009
(86) PCT No.: PCT/JP2009/063832

§ 371 Date: Jan. 31, 2011

(30) Foreign Application Priority Data
Jul. 31, 2008 (JP) 2008-198956

(51) Int. Cl. C09K 11/87; C09K 11/08

(52) U.S. Cl. 252/301.4 R

(57) ABSTRACT

Inorganic phosphor particles are provided, each of which containing: a matrix including at least one compound selected from the group consisting of II Group-XVI Group compounds, XII Group-XVI Group compounds, and mixed crystals thereof; and at least one metal element selected from the group consisting of metal elements belonging to Groups 6 to 11 in second transition series and third transition series of the periodic table, the metal element forming a luminescent center including wherein at least 30% of all the inorganic phosphor particles are particles each having at least 10 stacking fault planes at intervals of at most 5 nm.

### TECHNICAL FIELD

The present invention relates to inorganic phosphor particles useful for an alternating-current dispersed inorganic electroluminescent device, an alternating-current thin-film inorganic electroluminescent device, a direct-current thin-film inorganic electroluminescent device and the like.

### BACKGROUND ART

Phosphors are materials that emit light when energy, such as light, electricity, pressure, heat or electron beams, is applied thereto externally, and they are materials having been known for a long time. Of such materials, the phosphors made up of inorganic materials have been used in Braun tubes, fluorescent lamps, electroluminescent (EL) devices and the like from their photoemission characteristics and stability. In recent years, research has been actively done on inorganic phosphors for uses as color conversion materials in LEDs and those for excitation by slow electron beams as in PDPs.

Electroluminescent (EL) devices using inorganic phosphors are roughly classified as alternating-current drive or direct-current drive according to their driving methods. Alternating-current-drive EL devices are divided into two types, a dispersed type that phosphor particles are dispersed in highly dielectric binder and a thin-film type that a thin film of phosphor is sandwiched between two dielectric layers. In direct-current-drive EL devices are included direct-current thin-film EL devices which each have a thin film of phosphor sandwiched between a transparent electrode and a metal electrode and are driven by low-voltage direct current.

Next, the direct-current-drive inorganic EL devices are taken up for illustration.

Research on direct-current-drive inorganic EL devices was being conducted actively in the 1970-80s (Journal of Applied Physics, 52(9), 5797, 1981). The EL device of this type is a device structured to have a film of ZnSe:Mn which is formed on a GaAs substrate by use of MBE and sandwiched between the substrate and an Au electrode. The mechanism of luminescence by such a device consists in that, when a voltage of about 4V is applied to the device, electrons are injected from the electrode by the tunnel effect and excite Mn as luminescent center. However, such a device has low luminous efficiency (up to 0.05 μm/W) and low reproducibility, so even scientific research thereof, much less commercialization, has not been conducted since then.

Of late a new direct-current-drive inorganic EL device has been reported (WO 07/043,676 brochure). The new device uses as its luminescent material a ZnS system containing luminescent centers hitherto known, such as Cu or Mn, and has a structure that the ZnS system is sandwiched between an ITO electrode as a transparent electrode and an Ag electrode as a back electrode. Although the document has no description of the luminescence mechanism of the device, a conceivable mechanism is that Cu and CI contained together in the system form a DA pair, and via the pair the injected electron and hole are recombined and emit light.

In comparison with organic EL devices which emit light by a driving method similar to the above, the luminescent device all constituents of which are inorganic materials has high durability and allows full use in various fields, such as illumination and display. LEDs driven likewise have a similarity in that all constituents of each are inorganic materials, but the light emission from LEDs is minimal in area, or equivalently, point light emission. Therefore, although LEDs produce lasers of high intensity per unit area, the lasers produced are short of absolute light quantity (luminous flux); as a result, LEDs are of limited application. On the other hand, inorganic EL devices give off surface light emission by nature, so they have an advantage in the possibility of delivering quantities of light flux.

In addition, JP-A-2006-233147 discloses the inorganic phosphor made up of zinc sulfide particles containing copper as an activator, at least either chlorine or bromine as a co-activator and at least one metal element belonging to Groups 6 to 10 in the second or third transition series, and JP-A-4-270780 discloses the phosphor containing zinc sulfide as its matrix, copper as an activator, at least either chlorine or bromine as the first co-activator and gold as the second co-activator.

Furthermore, JP-A-2006-199794 discloses the method of manufacturing a phosphor by using a rare-earth sulfide as a material for its matrix, incorporating Pr, Mn and Au into the material for the matrix, preparing a mixture of the resulting material for the matrix and an activator for activating the material for the matrix, and activating the material for the matrix by heating the mixture.

WO 08/013,243 brochure describes the method of manufacturing precursors of phosphors, which is characterized in that phosphor matrices are doped with activators under impact pressure of 0.1 GPa or above.

JP-A-2006-63317 discloses the electroluminescent phosphor having an average particle size of 0.5 to 20 μm and stacking faults of 10 or more layers at intervals of at most 5 nm, containing copper as luminescent centers and further containing gold, cesium, bismuth or/and the like.

### SUMMARY OF INVENTION

However, every one of WO 07/043,676, JP-A-2006-233147, JP-A-4-270780 and JP-A-2006-199794 has neither particular description about stacking faults nor description about relationship between occurrence of stacking faults and being doped with metal elements belonging particularly to Groups 6 to 11 in the second and third transition series in the periodic table. Therefore, even though phosphor particles are manufactured through addition of the metal elements to the material for their matrix, the metal elements are present only on the particle surfaces and the interior of the particles is not doped with metal elements in sufficient amounts. So, these particles are not good in performance as a luminescent material. Although the manufacturing method of imposing impact pressure is described in WO 08/013,4243, the document is silent on the stacking faults. As our retest result, no increase in number of stacking faults was observed. In JP-A-2006-63317, though there is description about incorporation of gold, cesium and/or bismuth, the incorporation of these elements is limited to phosphors containing copper as luminescent centers. And the document is silent on other luminescent centers.

In these circumstances, development of new phosphors having matrices doped with sufficient quantities of metal elements forming luminescent centers and belonging to Groups 6 to 11 in the second or third transition series in the periodic table has been expected.

Therefore, the invention aims to provide inorganic phosphor particles that can ensure sufficient luminous efficiency through doping its matrix with a sufficient quantity of metal element which belongs to Groups 6 to 11 in the second transition series and the third transition series in the periodic table and forms luminescent centers, and further to provide methods of manufacturing a light-emitting device and a direct-current thin-film inorganic electroluminescent device by using those inorganic phosphor particles.

As a result of our intensive study, it has been found that novel inorganic phosphor particles capable of giving off photoluminescence by ultraviolet excitation and electroluminescence by direct-current drive can be formed by introducing high-density stacking faults into inorganic phosphor particles through addition of a metal element, which forms luminescent centers and belongs to Groups 6 to 11 in the second transition series and the third transition series in the periodic table, to their matrix formed of at least one compound chosen between a II Group-XVI Group compound and a XII Group-XVI Group compound, or a mixed crystal of these compounds, thereby achieving the invention.

More specifically, the invention is achieved by meeting the requirements as described below.

(1) Inorganic phosphor particles, each of which containing:
a matrix including at least one compound selected from the group consisting of II Group-XVI Group compounds, XII Group-XVI Group compounds, and mixed crystals thereof; and
at least one metal element selected from the group consisting of metal elements belonging to Groups 6 to 11 in second transition series and third transition series of the periodic table, the metal element forming a luminescent center,
wherein at least 30% of all the inorganic phosphor particles are particles each having at least 10 stacking fault planes at intervals of at most 5 nm.

(2) The inorganic phosphor particles as described in item (1) above,
wherein each of the inorganic phosphor particles further containing at least one element selected from the group consisting of elements belonging to Group 13 of the periodic table and elements belonging to Group 15 of the periodic table.

(3) The inorganic phosphor particles as described in item (2) above,
wherein the elements belonging to Group 13 is selected from the group consisting of Ga, In and Tl, and
the element belonging to Group 15 is selected from the group consisting of N, P, Sb and Bi.

(4) The inorganic phosphor particles as described in item (1) or (2) above,
wherein the metal element is selected from the group consisting of Os, Ir and Pt.

(5) A light-emitting device, comprising:
the inorganic phosphor particles as described in any of items (1) to (4) above.

6. A direct-current-drive inorganic EL device, comprising:
the inorganic phosphor particles as described in any of items (1) to (4) above.

7. A method of manufacturing a direct-current-drive inorganic EL device, the method comprising:
evaporating the inorganic phosphor particles as described in any of items (1) to (4) above.

### BRIEF DESCRIPTION OF DRAWINGS

FIG. 1 is a schematic diagram showing the structure of the direct-current-drive inorganic EL device made in Example 3, wherein 1 denotes a glass substrate, 2 denotes a first electrode, 3 denotes a first luminescent layer, 4 denotes a second luminescent layer, and 5 denotes a second electrode.

### DESCRIPTION OF EMBODIMENTS

Detailed description of the invention is given below.

The present inorganic phosphor particles (also referred to as the inorganic fluorescent material) are inorganic phosphor particles having a matrix formed of at least one compound chosen between a II Group-XVI Group compound and a XII Group-XVI Group compound, or a mixed crystal of these compounds, and characterized in that the particles contained as an element forming luminescent centers at least any of metal elements belonging to Groups 6 to 11 in the second transition series and the third transition series in the periodic table and at least 30% of all the particles are particles having at least 10 stacking fault planes at intervals of at most 5 nm.

The term “inorganic phosphor particles” as used herein means an aggregate of particles having planar stacking faults, namely a particulate element (or a dispersive element) containing particles having planar stacking faults.

The expressions of “a II Group-XVI Group compound” and “a XII Group-XVI Group compound”, which are compounds usable as materials for the matrix of inorganic phosphor particles, refer to a compound containing at least one element belonging to Group 2 in the periodic table and at least one element belonging to Group 16 in the periodic table and a compound containing at least one element belonging to Group 12 in the periodic table and at least one element belonging to Group 16 in the periodic table, respectively, and they are wordings/expressions commonly used by persons having general knowledge in the technical field to which the invention belongs (persons skilled in the art).

As an example of a material for the matrix, one compound chosen between a II Group-XVI Group compound and a XII Group-XVI Group compound, such as ZnS, ZnSe, ZnTe, CdS, CdSe, CdTe, CaS, SrS, SrSe or BaS, or a mixed crystal of both the compounds can be used. Suitable examples of a material for the matrix include ZnS, ZnSe, ZnSSe, SrS, CaS, SrSe and SrSSe. Of these compounds, ZnS, ZnSe and ZnSSe are preferred over the others.

The metal element forming luminescent centers contained in the present inorganic phosphor particles is a metal element belonging to Groups 6 to 11 in the second transition series or the third transition series in the periodic table. Examples of such a metal element include Mo, Tc, Ru, Rh, Pd, Ag, W, Re, Os, Ir, Pt and Au. Of these metal elements, Ru, Pd, Os, Ir, Pt and Au are preferable to the others, and Os, Ir, and Pt are preferable by far. These metal elements may be contained alone, or as combinations of two or more thereof.

In addition, the present phosphor particles are particles at least 30% of which are made up of particles each having at least 10 stacking fault planes at intervals of at most 5 nm. And it is preferable that the particles each having at least 10 stacking fault planes at intervals of at most 5 nm make up 50% or more, especially 80% or more, of all the particles.

The term “stacking fault” as described herein refers to a twin plane and a phase interface. Taking zinc sulfide as an example, these planes make plane defects perpendicular to {111} planes in ordinary cases. Detailed explanations of general stacking faults can be found in B. Henderson, Lattice Defects, chapters I and VII (translated by Masao Doyama and published by MARUZEN Co., Ltd.). And the case of zinc sulfide is described in Andrew C. Wright and lan V. F. Viney, Philosophical Mag. B, 2001, Vol. 81, No. 3, pp. 279-297.

Evaluation of stacking faults is made by observing stack structures appearing on the lateral faces (surfaces) of phosphor particles when the particles are etched with an acid like hydrochloric acid. Particles which each have at least 10 planar stack structures at intervals of at most 5 nm are the present particles that have stacking faults.

An increase in the number of stacking faults allows provision of spaces for admission of metal elements belonging to Groups 6 to 11 in the second and third transition series in the periodic table; as a result, phosphor particles great in the number of stacking faults can have an improved rate of doping with the metal elements as compared with phosphor particles small in the number of stacking faults. By use of the thus obtained phosphor particles that are high in doping rate, the phosphor layer formed by vapor deposition or the like can also have a high doping rate. Furthermore, since the stacking faults function as primary capture sites of electrons and holes, they have a role to play in preventing electrons and holes from suffering deactivation prior to recombination, and conduce to a further improvement in luminous efficiency.

The stacking faults can be increased on the occasion of e.g. doping as mentioned hereafter.

It is known that the intervals of these stacking plane faults have fine structures.

When observation of transmission electron micrographs is actually made on fragments obtained by pulverizing the present particles having stacking faults, it is noticed that each fragment has 10 or more stacking fault planes at intervals of 5 nm or less. In this way, although the present particles each have 10 or more stacking fault planes at high-density intervals of 5 nm or less, the number of the stacking fault planes is preferably 15 or more, far preferably 18 or more.

The stacking faults are each present at an interface between adjacent layer structures and, when etching is done, they become visible on the surface in the form of stripes. These layer structures are present throughout each individual particle, and can be counted exactly by means of SEM and TEM. In addition, when the material is pulverized and cleaved perpendicularly to the stacking fault planes, layer structures can also be clearly observed under a transmission electron microscope. For instance, when the phosphor particles are ground with an agate mortar and their fragments obtained are observed under TEM, it is also possible to directly examine every interval between stacking faults and the number of stacking fault planes. When a fragment has 10 or more stacking fault planes at intervals of 5 nm or less, nine or more interfaces can be observed on the survey of a 50-nm segment of fragment surface.

The phosphor particles have no particular restriction on their crystal structure. For instance, zinc sulfide may have any abundance ratio between the sphalerite (cubic) structure and the wurtzite (hexagonal) structure.

The method for incorporation of the metal element, which belongs to Groups 6 to 11 in the second or third transition series in the periodic table, into a material for the matrix, namely the doping method, is not confined to any particular method. For example, the metal element may be incorporated in the form of a metal salt at the time of particle formation under burning or, when a compound of the metal element melts, sublimes or reacts under burning conditions, the compound may be incorporated in crystal form. For the incorporation of the metal element, doping by burning in particular is favorable.

As the metal salt, any of compounds including oxides, sulfides, sulfates, oxalates, halides, nitrates and nitrides may be employed. Of these salts, oxides, sulfides and halides are preferred over the others. These salts may be used alone, or as combinations of two or more thereof.

The amount of the metal element used for doping is preferably from 1×10⁻⁷ to 1×10⁻¹ mole, far preferably from 1×10⁻⁵ to 1×10⁻² mole, per mole of material for the matrix.

The average diameter of the particles that make up the present phosphor is preferably from 0.5 to 20 μm, far preferably from 0.5 to 15 μm, particularly preferably from 1.0 to 12.0 μm. In the invention, the coefficient of variation in particle diameters (particle sizes) can be calculated by the expression C.V.=(standard deviation of volume-weighted particle size distribution÷volume-weighted average particle size)×100%, and the value calculated is 35% or below, preferably 30% or below, far preferably from 3% to 25%, particularly preferably from 3% to 20%. The size of each individual particle is represented as the diameter of a sphere equivalent to the particle volume. The sizes of individual particles may be measured using the electron micrographs taken, or the distribution thereof may be determined by an optical measurement or calculated from the sedimentation rate.

Stacking faults are generated in the interior of phosphor particles by burning. So, the burning is carried out twice in order that phosphor particles may be fined down and have a greater number of stacking faults, and it is preferred that the first burning and the second burning be performed under their respective conditions chosen as appropriate.

Additionally, the density of stacking faults in phosphor particles can be substantially increased without destroying the particles by imposing an impact force of magnitude within a certain range on the particles, preferably the burned particles obtained by the first burning (intermediary phosphor particles).

Examples of a method which can be used suitably for application of an impact force to phosphor particles include a method of bringing the particles into contact mixing, a method of mixing the particles in the presence of spherical bodies like alumina (by means of a ball mill), a method of accelerating the particles and making them collide with one another, a method of irradiating the particles with ultrasonic waves, a method of applying hydrostatic pressure to the particles, and a method of generating momentary pressure by the burst shock of an explosive or the like.

For explanation of methods for making an impact on phosphor particles, the method of using a ball mill is taken as an example.

The material which can be suitably used for the vessel and balls of a ball mill is glass, alumina, zirconia or the like, but in point of contamination with balls, alumina and zirconia are preferable to others. It is appropriate that the diameters of balls used be within the range of 0.01 to 10 mm, preferably 0.05 to 1 mm. By choosing the optimum diameters of balls, the balls can be easily separated from the intermediary phosphor particles after the treatment, what's more, the intermediary phosphor particles are easy to avoid crushing and undergo uniform stress. Mixing with two or more kinds of balls different in diameter is also favorable, because the mixing makes it possible to apply uniform stress to the intermediary phosphor particles. The suitable proportions in which the intermediary phosphor and balls are mixed are within the range of 1-100 parts by mass balls, preferably 2-20 parts by mass balls, to 1 part by mass intermediary phosphor. The suitable loading rate of a ball-intermediary phosphor mixture is within the range of 10-60 vol % to the volume of the vessel. The number of revolutions of a ball mill is chosen as appropriate in accordance with the outside diameter of the vessel. The suitable linear velocity during the revolutions is within the range of 1-500 cm/sec, preferably 10-100 cm/sec, and it is appropriate that the number of revolutions be adjusted to impart a semicircular motion to the ball-intermediary phosphor mixture in the vessel and bring the tilt angle of balls in revolution into a range of 5-45 degrees. The suitable operation time of a ball mill, though varies depending on the conditions including the number of revolutions, is within the range of 1 minute to 24 hours, preferably 10 minutes to 3 hours. It is preferred that those conditions be combined as appropriate from the luminance and longevity of the EL phosphor. The foregoing is a method of operating the ball mill under dry conditions. In the case of operating the ball mill under wet conditions, on the other hand, organic solvents such as alcohols and ketones can be used in addition to water. Although the optimum amount of solvents added is an amount just enough to fill in gaps between balls, addition of solvents in an amount 1 to 10 times as large as the loading volume is adequate for enhancing flowability of the mixture. By optimizing the amount of solvents added, the flowability of the mixture is kept and application of uniform stress becomes easy. For the purpose of enhancing flowability of the mixture, a surfactant, water glass or the like may be added as a dispersant. And it is preferred that other conditions adopted for operating the wet ball mill be within the same ranges as those for operating the dry ball mill.

In the case of applying stress by means of balls, it is also possible to use a device for forcedly stirring the balls with an impeller, a rotor or the like, a device for vibrating the vessel, or so on.

The probability of generation of stacking faults by simple application of an impact force is low, and stacking faults are generated at high densities by further performing subsequent burning.

In doping a material for the matrix with metal elements belonging to Groups 6 to 11 in the second transition series and the third transition series, it is preferred that the portions of the metal elements which are precipitated on and adsorbed to the crystal surfaces of the material, other than the portion incorporated into the interior of the crystals, be eliminated by etching, cleaning and the like.

For instance, it is preferred that the phosphor particles be obtained after going through processes of eliminating metal oxides adhering to the crystal surfaces by etching with an acid like HCl, further eliminating oxides (e.g. ZnO) still adhering to the crystal surfaces by cleaning with a chelating agent, such as KCN or 8-quinolinol, and drying the cleaned crystal surfaces.

Additionally, the Cu content in the present phosphor particles is preferably at most 1×10⁻⁷ times by mole the matrix content, and it is preferable by far that the present phosphor particles contain no Cu element.

Incorporation of at least one element chosen from the elements belonging to Group 13 or Group 15 in the periodic table is effective for enhancement of capabilities as phosphor particles.

More specifically, incorporation of at least one element chosen from the elements belonging to Group 13 and at least one element chosen from the elements belonging to Group 15 is preferred, incorporation of at least one element chosen from Ga, In or Tl as the element in Group 13 and at least one element chosen from N, P, Sb, As or Bi as the element in Group 15 is far preferred, and incorporation of Ga as the element in Group 13 and at least one element chosen from N, P or Sb as the element in Group 15 is particularly preferred.

In incorporating these elements into phosphor particles, it is advantageous to add a compound containing element(s) belonging to Group 13 and element(s) belonging to Group 15 (a XIII Group-XV Group compound).

The content of at least one element chosen from the elements belonging to Group 13 or Group 15 in the periodic table, though not particularly limited, is preferably from 1×10⁻⁷ mole to 1×10⁻² mole per mole of material for the matrix.

Next, a light-emitting device according to the invention is described in detail.

Light-emitting devices using inorganic phosphors, namely inorganic EL devices, include those which produce luminescence by direct-current drive and those which produce luminescence by alternating-current drive. What are known as the inorganic EL devices of the type which produce luminescence by direct-current drive are devices of structure built up of an electrode, a luminescent layer formed on the electrode by subjecting a phosphor to electron-beam evaporation and an electrode layer formed on the luminescent layer. One electrode is a transparent electrode made of ITO or the like, and the other electrode is a metallic electrode made of Al or the like. The device may be formed in an order that a thin phosphor film is formed on a transparent electrode, and then a metallic electrode layer is formed on the thin phosphor film, or in another order that a thin phosphor film is formed on a metallic electrode, and then a transparent electrode layer is formed on the thin phosphor film. The inorganic EL devices of such structure are referred to as thin-film inorganic EL devices. On the other hand, what are known as inorganic EL devices of the type which produce luminescence by alternating-current drive are devices of structure that inorganic phosphor particles dispersed in a binder having a high dielectric constant are sandwiched between a transparent electrode and a back electrode formed of metal. The inorganic EL devices of such structure are referred to as dispersed EL devices.

While alternating-current-drive inorganic EL devices are generally driven through application of a voltage of 50-300 V at a frequency of 50-5,000 Hz, direct-current-drive inorganic EL devices feature the ability to be driven at a low voltage of 0.1-20 V. The present inorganic phosphor particles are useful for not only alternating-current-drive devices including dispersed inorganic EL devices and thin-film inorganic EL devices but also direct-current-drive inorganic EL devices. Of all these devices, direct-current-drive inorganic EL devices are devices for which the present phosphor particles are especially useful.

Then the direct-current-drive inorganic EL devices are described in detail.

A direct-current-drive inorganic EL device is made up of at least a transparent electrode (also referred to as a transparent conductive film), a phosphor layer (also referred to as a luminescent layer) and a back electrode. When the luminescent layer is too thick, attainment of the electric field intensity required for producing luminescence is attended with a rise in the voltage between both electrodes. For achieving low-voltage drive, it is therefore appropriate that the thickness of the luminescent layer be 50 μm or below, preferably 30 μm or below. On the other hand, when the luminescent layer is too thin, the electrodes formed on both sides of the luminescent layer tend to make a short circuit. For avoiding occurrence of a short circuit, it is appropriate that the thickness of the luminescent layer be at least 50 nm, preferably at least 100 nm.

In forming the luminescent layer, general methods for forming inorganic materials into films, such as physical evaporation methods including a resistance-heating evaporation method and an electron-beam evaporation method, sputtering, ionic plating and CVD (Chemical Vapor Deposition), can be adopted. Since the phosphor particles according to the invention are stable even at high temperatures and have a high melting temperature, the method suitable for use in the invention is an electron-beam evaporation method which is fit for evaporation of materials high in melting temperature, or a sputtering method in cases where evaporation sources can be made into targets. In performing electron-beam evaporation, when the vapor pressures of metals incorporated into phosphor particles are substantially different from the vapor pressure of a material for their matrix, it is also useful to adopt an evaporation method of utilizing a plurality of evaporation sources as independent evaporation sources. Moreover, in the sense of enhancing crystallinity, an MBE (Molecular Beam Epitaxy) method which gives consideration to lattice matching with a substrate is also used to advantage.

The surface resistivity of transparent conductive film used suitably in the invention is preferably 10Ω/□ or below, far preferably from 0.01 to 10Ω/□, particularly preferably from 0.01 to 1Ω/□.

The surface resistivity of transparent conductive film can be measured in conformance with the method described in JIS K6911.

The transparent conductive film is formed on a glass or plastic substrate, and it preferably contains tin oxide.

As the glass, though typical glass such as non-alkali glass or soda-lime glass can be used, glass having high heat resistance and high flatness is preferably used. As the plastic substrate, transparent film such as polyethylene terephthalate film, polyethylene naphthalate film or cellulose triacetate base can be used to advantage. On any of these substrates, a transparent conductive substance such as indium tin oxide (ITO), tin oxide or zinc oxide can be deposited and formed into film by evaporation, coating, printing or a like method.

In this case, it is favorable for enhancement of durability that tin oxide predominates in the surface layer of the transparent conductive film.

The deposition amount of a transparent conductive substance as a constituent of the transparent conductive film is preferably from 100% to 1% by mass, far preferably from 70% to 5% by mass, further preferably from 40% to 10% by mass, of the transparent conductive film.

The method for preparing a transparent conductive film may be a gas phase method such as sputtering or vacuum evaporation. Alternatively, ITO or tin oxide in a pasty state may be formed into film by coating or screen printing and heated in its entirety, or it may be formed into film by heating with laser.

For the transparent conductive film used in the present EL devices, any of commonly used transparent electrode materials may be used. Examples of such a transparent electrode material include oxides, such as tin-doped tin oxide, antimony-doped tin oxide, zinc-doped tin oxide, fluorine-doped tin oxide and zinc oxide, a multilayer structure having a thin silver layer sandwiched between high-refraction layers, and conjugated polymers such as polyaniline and polypyrrole.

For further lowering the resistance, it is appropriate that current-carrying properties be improved by disposing reticulated or banded metallic fine wires, such as grid-shaped or comb-shaped metallic fine wires. Suitable examples of metal or alloy for the fine wires include copper, silver, aluminum and nickel. Such metallic fine wires may have an arbitrary thickness, but the preferred range of their thickness is from around 0.5 μm to 20 μm. The metallic fine wires are preferably disposed with 5-μm to 400-μm pitches, especially with 100-μm to 300-μm pitches. Since the light transmittance is reduced by disposing metallic fine wires, minimization of this reduction is important, and it is advantageous to ensure the light transmittance in a range of 80% to less than 100%.

The meshes of metallic fine wire may be stuck on transparent conductive film, or metal oxide or the like may be coated or deposited on metallic fine wires formed in advance on the film by mask evaporation or etching. Alternatively, the metallic fine wires may be formed on a thin film of metal oxide prepared in advance.

On the other hand, though different from the above in forming method, transparent conductive film suitable for the invention can be formed by lamination of metal oxide and a metallic thin film having an average thickness of 100 nm or below instead of metallic fine wires. As metals used for the metallic thin film, those having high corrosion resistance and excellent malleability and ductility, such as Au, In, Sn, Cu and Ni, are suitable, but usable metals are not limited to those metals in particular.

It is preferred that such multilayer film achieve high light transmittance, specifically light transmittance of 70% or higher, particularly preferably 80% or higher. The wavelength at which the light transmittance is defined is 550 nm.

The light transmittance can be measured by using an interference filter for extraction of 550-nm monochromatic light and integration actinography using a typical white light source, or with a spectrum measuring device.

### (Back Electrode)

Any of electrically conductive materials can be used for the back electrode provided on the side of which no light is taken out. According to the form of a device to be made, the temperatures in making processes and so on, the electrically conductive material for the back electrode can be chosen as appropriate from among metals, such as gold, silver, platinum, copper, iron and aluminum, or graphite. And it is important for the material chosen to have high thermal conductivity, preferably a thermal conductivity of 2.0 W/cm deg or higher.

For ensuring a high degree of heat dissipation into the periphery of the EL device and high current-carrying capacity, the use of a metal sheet or a mesh of metal wires is also suitable.

The method applicable to formation of the present inorganic phosphor particles may be identical with the burning method (solid-phase method) widely used in the field except that it includes the process of introducing a greater number of stacking faults.

Taking the case of zinc sulfide, fine-particle powder having particle diameters in the 10- to 50-nm range (referred to as crude powder) is prepared by the liquid-phase method and used as primary particles. Impurities called activators are mixed in the primary particles, and the resulting particles are placed in a crucible together with flux and subjected to first burning at a high temperature of 900° C. and 1,300° C. for a time period of 30 minutes to 10 hours, thereby obtaining particles. The particles as intermediate phosphor powder obtained by the first burning are washed repeatedly with ion exchange water to remove alkali metals or alkaline-earth metals and excesses of activator and co-activator. In this course, it is preferred that the process of introducing stacking faults be employed as appropriate. And subsequently the intermediate phosphor powder thus obtained is subjected to second burning. The second burning is performed by heating (annealing) at a lower temperature of 500° C. to 800° C. for a shorter time period of 30 minutes to 3 hours as compared to the first burning.

The direct-current-drive inorganic EL device can be made through the evaporation using the present inorganic phosphor particles as an evaporation source. More specifically, the EL device can be made by subjecting the phosphor particles obtained in the forgoing manner to physical evaporation, such as electron-beam evaporation, preferably after the phosphor particles are molded under pressure.

### EXAMPLES

The invention will now be illustrated in more detail by reference to the following examples, but these examples should not be construed as limiting the scope of the invention.

### Example 1

### Sample A

Particulate powder of zinc sulfide (ZnS) in an amount of 25 g, dry powder of iridium chloride in an amount of 2×10⁻⁴ mole per mole with respect to the amount of zinc included in ZnS, flux powder composed of NaCl, MgCl₂ and ammonium chloride (NH₃Cl) in an appropriate amount and magnesium oxide powder in an amount of 10% by mass based on the phosphor powder were placed in an alumina crucible, burned at 1,150° C. for 2 hours, and then cooled. Into a glass jar of 15 mm φ, the particles having undergone the burning and 1-mm alumina balls were charged in the proportion of 5 g particle to 20 g alumina ball and subjected to ball milling of 60 minutes at a rotation speed of 10 rpm. Thereafter, separation of intermediate phosphor particles from the alumina balls was achieved by means of a 100-mesh sieve. To the intermediate phosphor particles separated, 5 g of ZnO and 0.25 g of sulfur were further added. The thus prepared dry powder was placed in an alumina crucible, and burned again at 700° C. for 6 hours. The burned particles were pulverized again, cleaned by undergoing dispersion into H₂O at 40° C., sedimentation and supernatant removal in succession, then admixed with a 10 mass % aqueous solution of hydrochloric acid and subjected to dispersion, sedimentation and supernatant removal to eliminate unnecessary salts, and further dried. In addition, oxides including ZnO on the particle surfaces were eliminated with a 10 mass % aqueous solution of KCN heated to 70° C. Furthermore, the surface layer in a quantity equivalent to 10 mass % of the whole of the particles was removed by etching with 6N hydrochloric acid.

By further sieving the thus obtained particles, small-size particles were taken out.

By grinding the thus obtained phosphor particles by means of an earthenware mortar, fragments having thicknesses of 0.2 μm or below were picked out and observed under an electron microscope on condition that the acceleration voltage was 200 kV. As a result, it was found that 32% (by number) of the observed particulate fragments contained portions which each have at least 10 stacking fault planes at intervals of 5 nm or below.

### Sample B

Sample B was prepared in the same manner as Sample A, except that the ball milling was carried out for 90 minutes. When the Sample B fragments were observed under the electron microscope in the same way as the Sample A fragments, it was found that 56% (by number) of the observed particulate fragments contained portions which each have at least 10 stacking fault planes at intervals of 5 nm or below.

### Sample C

Sample C was prepared in the same manner as Sample A, except that the ball milling was carried out for 120 minutes. When the Sample C fragments were observed under the electron microscope in the same way as the Sample A fragments, it was found that 81% (by number) of the observed particulate fragments contained portions which each have at least 10 stacking-fault planes at intervals of 5 nm or below.

### Sample D

Sample D was prepared in the same manner as Sample A, except that no ball milling was carried out. When the Sample D fragments were observed under the electron microscope in the same way as the Sample A fragments, it was found that 10% (by number) of the observed particulate fragments contained portions which each have at least 10 stacking fault planes at intervals of 5 nm or below.

The Ir content (the amount of Ir doping) in each of the thus prepared phosphors and the wavelength and intensity of photoluminescence (PL) produced when each phosphor was excited by 330-nm ultraviolet radiation are set forth in the following Table 1. The photoluminescence intensities shown in Table 1 are relative values, with Sample A being taken as 100.

TABLE 1

| | | | Incidence of | | | |
|---|---|---|---|---|---|---|
| | | | high-density | | | |
| | Amount | Amount | stacking | | | |
| | of IrCl₃ | of IrCl₃ | faults | Wavelength | | |
| | added | doped | (% by | of | Intensity of | |
| | (mol/mol | (mol/mol | number of | photoluminescence | photoluminescence | |
| | Zn) | Zn) | particles) | produced | produced | note |
| Sample A | 2 × 10⁻⁴ | 0.8 × 10⁻⁴ | 32% | 445 nm | 100 | Invention |
| Sample B | 2 × 10⁻⁴ | 1.3 × 10⁻⁴ | 56% | 445 nm | 230 | Invention |
| Sample C | 2 × 10⁻⁴ | 1.9 × 10⁻⁴ | 81% | 445 nm | 560 | Invention |
| Sample D | 2 × 10⁻⁴ | 0.1 × 10⁻⁴ | 10% | 451 nm | 11 | Comparative |
| | | | | | | example |

Sample D underwent no grinding with a ball mill, so it was low in incidence of such high-density stacking fault that at least 10 stacking fault planes were present at intervals of 5 nm or below, and besides, the amount of Ir doping which Sample D received was only about 5 mole % of the amount of Ir added to Sample D, so Sample D produced low intensity of photoluminescence. By contrast, as the incidence of the high-density stacking fault became higher in order of Sample A, Sample B and Sample C, not only Ir doping rate but also photoluminescence intensity became greater in that order. The main factor of these effects is thought to be stabilization of Ir presence by fixation of Ir to stacking faults.

### Example 2

Samples were prepared in the same manner as Sample C in Example 1, except that XIII Group-XV Group compounds, the species and addition amounts of which are set forth in Table 2, were added, respectively, after the grinding with the ball mill was carried out, and their photoluminescence intensities were measured. The measurement results are shown below. The photoluminescence intensities shown in Table 2 are also relative values, with Sample A being taken as 100. Additionally, each of Samples H to K was equivalent to Sample C in terms of incidence of stacking faults and wavelength of photoluminescence.

TABLE 2

| | Species of XIII Group-XV | |
|---|---|---|
| | Group compound | Intensity of |
| | (doping amount, mol/mol | photoluminescence |
| | Zn) | produced |
| Sample H | GaAs (2 × 10⁻⁴) | 780 |
| Sample I | InP (2 × 10⁻⁴) | 810 |
| Sample J | InSb (2 × 10⁻⁴) | 815 |
| Sample K | GaN (2 × 10⁻⁴) | 795 |

As can be seen from Table 2, addition of any XIII Group-XV Group compound (any compound containing both of elements belonging to Group 13 and Group 15 in the periodic table) further intensified the photoluminescence attributed to Ir doping. In particular, the addition of InSb conduced to the highest intensity of photoluminescence.

### Example 3

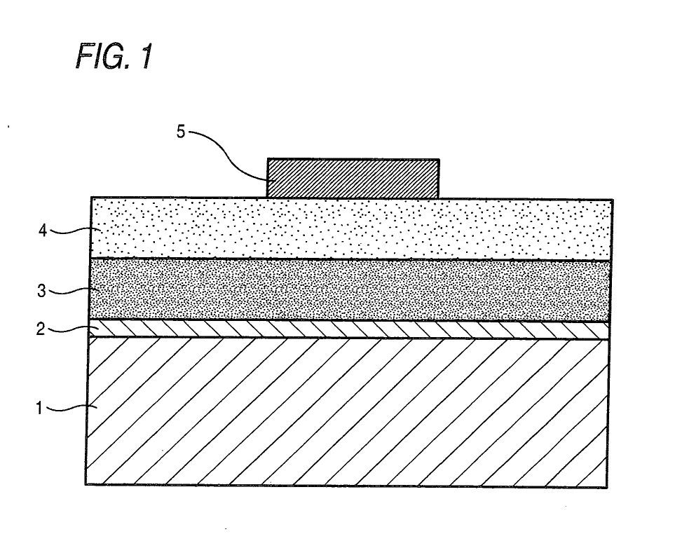

Direct-current-drive inorganic EL devices were made using the inorganic phosphor particles of Sample C prepared in Example 1 and those of each of Samples H to K prepared in Example 2, respectively. A diagrammatic sketch of the structure of each direct-current-drive inorganic EL device is shown in FIG. 1.

A first electrode (2) as a transparent electrode was provided on a transparent glass substrate 1 through formation of a 200 nm-thick ITO layer by sputtering. On the first electrode (2), the inorganic phosphor particles of each of Sample C and Samples H to K were formed into a film by means of EB evaporation apparatus. More specifically, the inorganic phosphor particles of each sample were placed as a first evaporation source, and metallic selenium as a second evaporation source. The inorganic phosphor particles were evaporated at a constant film-formation rate from the first evaporation source and, in the first half of film formation, the metallic selenium was evaporated from the second evaporation source at such a rate as to attain a selenium ratio of 0.5% or below by weight, thereby stacking a first luminescent layer (3) on the first electrode (2); while in the second half of film formation the metallic selenium was evaporated at such a rate as to attain a selenium ratio on the order of 1% by weight, thereby stacking a second luminescent layer (4) on the first luminescent layer (3). Herein, the time ratio between the first half and the second half of the film formation was approximately 1:1, and the total thickness of stacked layers was 2 μm. The set value of vacuum in the evaporation chamber used herein was 1.3×10⁻⁴ Pa and the substrate temperature was set at 200° C. Further, for the purpose of enhancing the crystallinity, 1-hour thermal annealing at 600° C. was performed in the same chamber after the film formation. Subsequently thereto, a 0.2 μm-thick film of silver as a second electrode (5) was evaporated onto the second luminescent layer (4) by resistance heating evaporation. Thus, each of the direct-current-drive inorganic EL devices was obtained.

A direct-current power supply was connected to the silver electrode of the second electrode (5) and the ITO of the first electrode (2) so that the former acted as positive electrode and the latter as negative electrode. When a current from the power supply was passed through each device, it was ascertained that each device showed luminescence. In particular, the device using Sample J delivered a better result that it was higher in luminance than other devices by at least 30%.

### INDUSTRIAL APPLICABILITY

The present inorganic phosphor particles not only show luminescence at unprecedentedly high luminous efficiency but also have usefulness as phosphor particles for inorganic electroluminescent devices, and they excel in luminance and have long life.

1. Inorganic phosphor particles, each of which containing:
a matrix including at least one compound selected from the group consisting of II Group-XVI Group compounds, XII Group-XVI Group compounds, and mixed crystals thereof; and
at least one metal element selected from the group consisting of metal elements belonging to Groups 6 to 11 in second transition series and third transition series of the periodic table, the metal element forming a luminescent center,
wherein at least 30% of the inorganic phosphor particles are particles each having at least 10 stacking fault planes at intervals of at most 5 nm.

2. The inorganic phosphor particles according to claim 1,
wherein each of the inorganic phosphor particles further containing at least one element selected from the group consisting of elements belonging to Group 13 of the periodic table and elements belonging to Group 15 of the periodic table.

3. The inorganic phosphor particles according to claim 2,
wherein the elements belonging to Group 13 is selected from the group consisting of Ga, In and Tl, and
the element belonging to Group 15 is selected from the group consisting of N, P, Sb and Bi.

4. The inorganic phosphor particles according to claim 1, wherein the metal element is selected from the group consisting of Os, Ir and Pt.

5. A light-emitting device, comprising:
the inorganic phosphor particles according to claim 1.

6. A direct-current-drive inorganic EL device, comprising:
the inorganic phosphor particles according to claim 1.

7. A method of manufacturing a direct-current-drive inorganic EL device, the method comprising:
evaporating the inorganic phosphor particles according to claim 1.
